(19) United States
(12) Patent Application Publication
(10) Pub. No.: US 2026/0313578 A1
(43) Pub. Date: Oct. 8, 2026

(54) NETWORK SLICE MANAGEMENT

(71) Applicant: Nokia Technologies Oy, Espoo (FI)

(72) Inventors: Halit Murat GÜRSU, München (DE); Philippe GODIN, Versailles (FR); György Tamás WOLFNER, Budapest (HU); Ömer BULAKCI, Munich (DE); Rajesh Babu NATARAJAN, K R Puram Bangalore (IN)

(21) Appl. No.: 19/108,258

(22) PCT Filed: Aug. 14, 2023
(86) PCT No.: PCT/EP2023/072370

§ 371 Date: Mar. 3, 2025

(30) Foreign Application Priority Data
Sep. 12, 2022 (FI) 20225789

(51) Int. Cl. H04W 60/00; H04W 48/20; H04W 60/04

(52) U.S. Cl. CPC H04W 60/002; H04W 48/20; H04W 60/04

(57) ABSTRACT

According to an example aspect of the present invention, there is provided an apparatus, such as a user equipment, configured at least to camp in idle or inactive state in a cell controlled by a base station which is included in a network, process, while remaining in the idle or inactive state, a network slice group definition validity indication received from the base station, trigger a non-access stratum registration update process with the network, wherein the non-access stratum registration update process includes the apparatus obtaining an updated network slice group mapping from the network, and use the updated network slice group mapping in a subsequent cell re-selection.

### FIELD

The present disclosure relates to wireless communication, such as wireless cellular communication.

### BACKGROUND

In wireless cellular communication systems, for mobility among neighboring cells, idle/inactive state user equipments, UEs, may rely on a cell reselection procedure. The purpose this procedure is to maintain the idle/inactive state UE is camped on a suitable cell. The network may influence cell reselection by adjusting broadcasted information of individual cells in different system information blocks, SIBs, for example. In general, SIBs contain parameters that the UE can use in evaluating the radio quality of the cell the UE is currently camped on, as well as neighboring cells to reselect to from the current cell as the UE moves across borders of coverage areas of different cells.

Network slicing is a network architecture solution that enables the multiplexing of virtualized and independent logical networks on the same physical network infrastructure. Each network slice is an isolated end-to-end logical cellular communication network tailored to fulfil diverse requirements requested by a particular application. Network slicing enables support for different services using the same underlying physical cellular network infrastructure. Network slices can differ either in their service requirements, such as ultra-reliable low latency communication, URLLC, or enhanced mobile broadband, eMBB, or the tenant operator that provides those services.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to camp in idle or inactive state in a cell controlled by a base station which is comprised in a network, process, while remaining in the idle or inactive state, a network slice group definition validity indication received from the base station, trigger a non-access stratum registration update process with the network, wherein the non-access stratum registration update process comprises the apparatus obtaining an updated network slice group mapping from the network, and use the updated network slice group mapping in a subsequent cell re-selection.

According to a second aspect of the present disclosure, there is provided an apparatus comprising at least one processing core and at least one memory storing instructions that, when executed by the at least one processing core, cause the apparatus at least to control at least one cell of a cellular communication network, process a network slice group validity index indicating which network slice to slice group mappings have changed, and provide, by broadcasting in system information of the cell or by transmission via a physical downlink control channel of the cell, a network slice group definition validity indication to at least one user equipment camping in idle or inactive state in the cell.

According to a third aspect of the present disclosure, there is provided a method comprising camping in idle or inactive state on a cell controlled by a base station which is comprised in a network, processing, while remaining in an idle or inactive state, a network slice group definition validity indication received from the base station, triggering a non-access stratum registration update process with the network, wherein the non-access stratum registration update process comprises obtaining an updated network slice group mapping from the network, and using the updated network slice group mapping in a subsequent cell re-selection.

According to a fourth aspect of the present disclosure, there is provided a method comprising controlling at least one cell of a cellular communication network, processing a network slice group validity index indicating which network slice to slice group mappings have changed, and providing, by broadcasting in system information of the cell or by transmission via a physical downlink control channel of the cell, a network slice group definition validity indication to at least one user equipment camping in idle state on the cell.

According to a fifth aspect of the present disclosure, there is provided an apparatus comprising means for camping in idle or inactive state on a cell controlled by a base station which is comprised in a network, means for processing, while remaining in the idle or inactive state, a network slice group definition validity indication received from the base station, means for triggering a non-access stratum registration update process with the network, wherein the non-access stratum registration update process comprises the apparatus obtaining an updated network slice group mapping from the network, and means for using the updated network slice group mapping in a subsequent cell re-selection.

According to a sixth aspect of the present disclosure, there is provided an apparatus comprising means for controlling at least one cell of a cellular communication network, means for processing a network slice group validity index indicating which network slice to slice group mappings have changed, and means for providing, by broadcasting in system information of the cell or by transmission via a physical downlink control channel of the cell, a network slice group definition validity indication to at least one user equipment camping in idle state on the cell.

According to a seventh aspect of the present disclosure, there is provided a non-transitory computer readable medium having stored thereon a set of computer readable instructions that, when executed by at least one processor, cause an apparatus to at least camp in idle or inactive state on a cell controlled by a base station which is comprised in a network, process, while remaining in the idle or inactive state, a network slice group definition validity indication received from the base station, trigger a non-access stratum registration update process with the network, wherein the non-access stratum registration update process comprises the apparatus obtaining an updated network slice group mapping from the network, and use the updated network slice group mapping in a subsequent cell re-selection.

According to an eighth aspect of the present disclosure, there is provided a non-transitory computer readable medium having stored thereon a set of computer readable instructions that, when executed by at least one processor, cause an apparatus to at least control at least one cell of a cellular communication network, process a network slice group validity index indicating which network slice to slice group mappings have changed, and provide, by broadcasting in system information of the cell or by transmission via a physical downlink control channel of the cell, a network slice group definition validity indication to at least one user equipment camping in idle state on the cell.

### BRIEF DESCRIPTION OF THE DRAWINGS

FIG. 1 illustrates an example system in accordance with at least some embodiments of the present invention;

FIG. 2 illustrates an example network slice group update;

FIG. 3 illustrates an example apparatus capable of supporting at least some embodiments of the present invention;

FIGS. 4-6 illustrate signalling in accordance with at least some embodiments of the present invention, and

FIG. 7 is a flow graph of a method in accordance with at least some embodiments of the present invention.

### EMBODIMENTS

Mechanisms are herein disclosed to address the issue of user equipments and radio access nodes, such as base stations, being insufficiently aware of changes made to network slicing configurations, such as slice to slice group mappings. User equipments may be informed of such changes while they are in the idle state using broadcasted system information or radio resource connection, RRC, short messages, as will be disclosed herein below. Radio access nodes may be informed of such changes by peer radio access nodes, or from a core network node, such as access and mobility function, AMF, or mobility management entity, MME. The disclosed methods provide the technical effect that they avoid a large paging cascade from occurring when slice group mappings are re-configured.

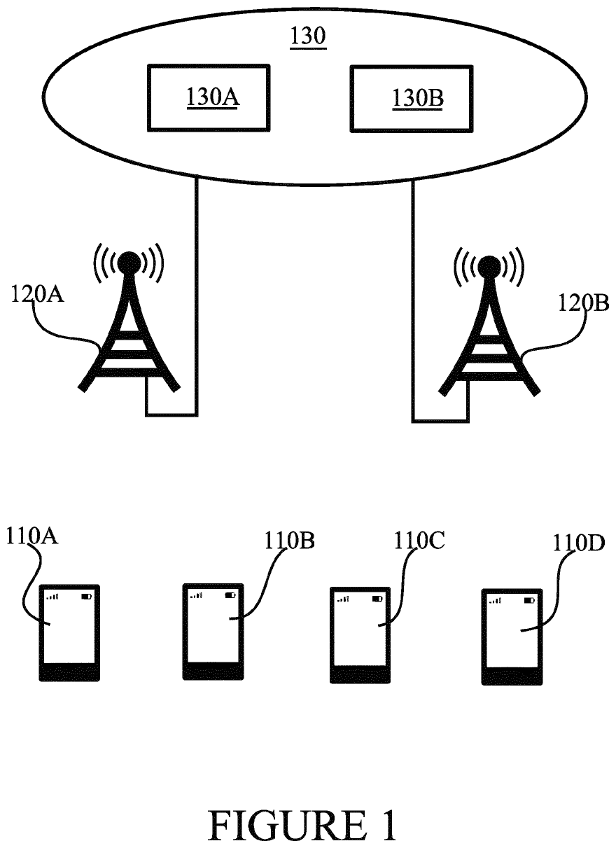

FIG. 1 illustrates an example system in accordance with at least some embodiments of the present invention. User equipments 110A, 110B, 110C and 110D are each camped on a cell controlled by base station 120A or 120B. One base station may control one, or more than one, cell. A user equipment may comprise, for example, a smartphone, a mobile phone, a connected car connectivity module, a smart utility meter, an Internet of Things node or a connected sensor node such as a closed-circuit television camera, for example. Base station 120A, 120B may be referred to as an eNB or gNB, for example, depending on the used radio access technology. In general base stations are radio access nodes, comprised in a radio access network, RAN, connecting over a radio interface to user equipments and, usually but not always, via a wired interface, directly or indirectly, with a core network 130. While discussed herein primarily as a base station, more generally a radio access node may perform functions of the processes disclosed here. Examples of radio access nodes include, in addition to base stations, elements of distributed base stations, such as distributed units, DUs, and central units, CUs. Base stations 120A, 120B are each coupled with a node in core network node 130.

Core network node 130A may be connected to gateway 130B, which may like core network node 130A be comprised in a core network 130 of the communication system. In general, a core network node may be tasked with functions which affect the system as a whole, such as managing switching of calls and providing subscriber registers. One example of a core network node is an access and mobility function, AMF. An AMF in a fifth generation, 5G, core network is configured to receive connection and session related information from UEs and to handle connection and mobility management tasks. Messages related to session management are forwarded from the AMF to a session management function, SMF, in the core network. A cellular communication system may comprise dozens, hundreds or even thousands of base stations. Cellular communication systems may be configured to interoperate with each other to enable subscriber roaming from a coverage area of one cellular system to a coverage area of another cellular system.

When moving about the coverage areas of adjacent cells, idle state UEs may rely on cell reselection procedures to maintain themselves camped on a cell they can reach, if needed. The network can influence the reselection procedure by adjusting the broadcast information of individual cells in different system information blocks, SIBs. These SIBs contain configuration parameters that the UE can use to evaluate the radio quality of a currently camped-on cell, as well as that of neighboring cells which are potential reselection targets. Cell re-selection procedures may be slice agnostic, that is, not considering network slice support of the neighboring cells while evaluating the neighbour cells as potential reselection targets. On the other hand, as reselecting to a cell which doesn't support the network slices the UE is interested in could cause an update process with the network, it may be useful to provide cell reselection priorities in order to guide the idle or inactive state UE preferentially to a cell which supports its allowed network slices. This is most useful from the point of view of interference for inter-frequency reselections. This is because not selecting the best cell and searching for another suitable cell in another frequency band would not incur interference. A slice group mapping may be used to define groups formed of network slices, for example based on a specific slice characteristic. For example, all network slices that can be accessed by a terminal device of a specific type may be used as a slice group, or network slices may be grouped based on another criterion. In detail, a mapping of network slices to slice groups may make signalling simpler, for example when advising idle or inactive state UEs concerning slice support in cells by using slice groups, rather than individual slices. Furthermore, the slice groups may be used to avoid security issues that can be caused by unencrypted broadcasting of a critical slice.

Communication from base station 120 to user equipment(s) 110A, 110B, 110C, 110D is termed the downlink direction, and communication from the user equipment(s) 110A, 110B, 110C and 110D to base station 120 is termed the uplink direction. Communication in the uplink may be performed using a dedicated channel or a shared channel, wherein a shared channel may be shared between more than one user equipment. When a shared channel is used, resources that constitute the physical channel need to be shared between the user equipments, such that no two user equipments use the same resources at the same time.

An idle state refers to a state where a user equipment, UE, is associated with a cell, known as camping on the cell, without an established radio resource control, RRC, connection. The base station controlling the cell does not have a context for the UE, and the location of the UE is not known to the network at an accuracy of the cell, but at an accuracy of a registration area, RA, which comprises one or more tracking area, each tracking area comprising one or more cells. UE contexts, when present in the base station, store information required to maintain radio-access network services towards an active UE. This information comprises UE state information, security information, UE capability information and the identities of UE-associated active logical connections, for example S1 connections. A reason for using the idle state is to reduce UE power consumption by utilizing, for example, discontinuous reception, DRX. The number of processes that the UE is required to perform in idle state is smaller than in a RRC connected state. For example, the UE in idle state may be required to wake up only periodically for a short time to perform a limited number of processes, for example, monitoring incoming calls and measurements for mobility, but the UE will then be allowed to re-enter a sleep mode to conserve power. RRC inactive state differs from idle in that the base station does have a context for the UE, and keep-alive signalling is maintained between the base station and a core network node. Thus a transition to connected state may occur faster from the inactive state, than the idle state.

In the network slicing model, the registration area, RA, of a UE supports the same slices from the perspective of the UE. When a UE registers to the network it can indicate the slices to which it might need access. The core network analyses the UE profile and subscription data to verify the list of slices the UE can really have access to. As a result, the core network sends a list of allowed slices to the UE, that is, a list of allowed slice identities. An example of slice identity is a single-network slice selection assistance information, NSSAIs. The list of allowed slices could be different, or only a subset, of the slices requested from the UE in the registration process. If the allowed slices contain at least one slice then the core network also configures a RA for that UE. This RA contains a list of TAs in which all the allowed slices of the UE are supported. The core network knows the current TA of the UE from its registration request and knows the slice support of the neighboring TAs. Based on this information the core network can configure the list of TAs for the UE in which the slice support is homogenous for the requesting UE. This list is the RA. Once the UE goes outside of the TAs in the RA, it needs to perform a registration area update, namely a mobility registration update procedure, and the core network re-evaluates the UE requested slices to configure a new registration area for the UE. The registration area update may be a non-access stratum, NAS, registration area update, for example.

In case of a mobile-terminated service request, such as a call, the network pages the base stations belonging to all the TAs of the RA. Thus, there is a trade-off between the size of the RA and paging overhead on the one hand, and RA update frequency on the other hand. In other words, a large RA implies fewer RA updates but more paging signaling, whereas a small RA implies more RA updates but less paging signaling. In addition, with a smaller RA, the UE could potentially be reached faster and thus a small RA might be preferred for certain services with delay constraints.

As noted, a UE in idle state is in a low-power mode and wakes up periodically to monitor for paging messages from the network. The network can reach UEs in idle state through paging message. The network can notify UEs in idle state of changes in system information blocks, SIB, and earthquake and tsunami warning system, ETWS, and commercial mobile alert system, CMAS, indications through RRC short messages. Both paging messages and RRC short messages are addressed with paging radio network temporary identifier, P-RNTI, on physical downlink control channel, PDCCH, but while the former is sent on paging control channel, PCCH, the short message is sent over PDCCH. SIBs are transmitted from base stations by broadcasting them, without addressing them to any specific UE or set of UEs. While discussed herein primarily in terms of idle state, the principles of the present disclosure may equally be applied to user equipments in inactive state.

A network slice list may be uniquely identified via a slice list identifier, such as an NSSAI. An example of an NSSAI is a single network slice selection assistance information, S-NSSAI. Current 3GPP specifications allow a UE to be simultaneously connected and served by at most eight network slices associated with eight S-NSSAIs. On the other hand, each cell may support tens or even hundreds of S-NSSAIs, whereas single a tracking area may support up to 1024 distinct network slices. The S-NSSAI may include both slice service type, SST, and slice differentiator, SD, fields with a total length of 32 bits, or include only an SST field part in which case the length of S-NSSAI is only 8 bits. The SST field may have standardized and non-standardized values. Values 0 to 127 may belong to a standardized SST range. For instance, SST value of 1 may indicate that the slice is suitable for handling of 5G eMBB, and SST 2 may indicate support for handling of URLLC, for example.

When providing advice to idle state UEs concerning slice support of cells or frequencies to consider in reselection decisions, a problem may occur in case slice support of cells is reconfigured. It is possible, that the UE will not receive an indication of such reconfiguration. In particular, re-configuring slice support in a cell may affect the mapping of slices to slice groups, wherefore the UE may misunderstand slice information expressed in terms of slice groups and perform a reselection to a cell which doesn't support its slices, causing an unnecessary registration area update with the network. In particular, previously distributed slice group mappings may be invalid if a newly configured slice requires introduction of a new slice group, or if the new slice will be part of an already existing slice group.

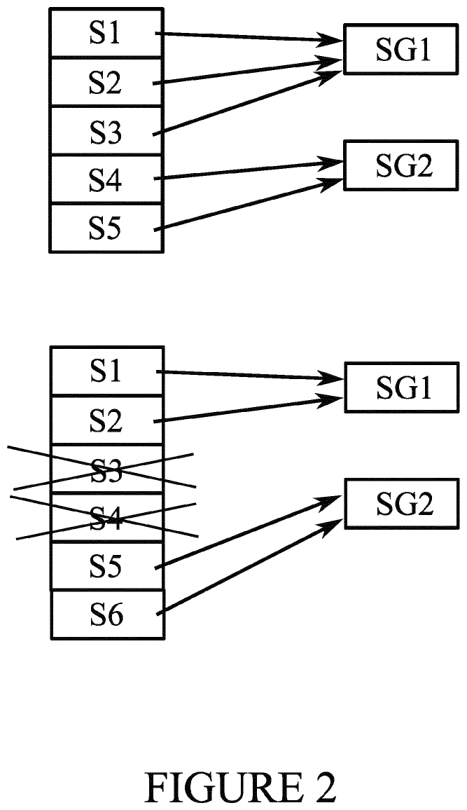

FIG. 2 illustrates an example network slice group update. Initially, in the upper part of the figure, network slices S1, S2 and S3 are comprised in slice group SG1, and network slices S4 and S5 are comprised in slice group SG2. Following one or more re-configuration actions, network slices S3 and S4 are discontinued and a new slice S6 is configured in the network, a situation illustrated in the lower part of the figure. Here, network slices S1 and S2 are comprised in slice group SG1, and network slices S5 and S6 are comprised in slice group SG2. In other words, the definitions of both slice group SG1 and SG2 have changed with respect to the situation in the upper part of the figure. The definition of which slices are comprised in which groups are a mapping of slices to the groups, known as a slice group mapping.

To avoid the situation where the UE has an old slice group mapping, the base station may broadcast at least one slice group validity index over a SIB which indicates slice group information. The format of the at least one slice group validity index may be one or more octets with one bit representing a slice group which has changed, for example. The mapping between a slice and a slice group and its associated broadcast slice group validity index may be sent from AMF to the base station and/or to the UE.

Whenever a slice group mapping has changed, the associated slice group mapping validity index may be set by AMF and signaled to at least one base station by the AMF so that the RAN broadcasts it in system information. The idle state UE may be informed by transmission of an RRC short message that system information has changed. UE may responsively decode block SIB1 to understand which SIB block has changed, for example. Furthermore, if the SIB that comprises slice group validity indices has changed, e.g., SIB16, the UE can acquire that SIB to detect which slice group(s) mapping validity index has been changed, and if the UE is impacted by this change it may then trigger a NAS registration update procedure to learn the new slice group mapping. In some embodiments, the UE may react to an RRC short message by directly receiving the correct, changed, SIB block, especially if the RRC short message has a slice update indicator. The SIB block with slice group information may include an indication of a time, when the last change was made, to enable UEs to decide, if they already have the updated slice group mapping.

Alternatively to providing the slice group mapping validity index via broadcasted system information, SIB, the network may provide in a RRC short message an indication, for example a single bit, that at least one slice group mapping has changed. After receiving the RRC short messages with such indications, UEs may responsively each trigger a NAS registration update procedure with the network to learn the new slice group mappings. As UE registration updates can create a burst of signaling, the UEs may be preconfigured to use a randomized time delay value to spread the NAS registration update triggers over the duration of this timer. This option may be preferable when a high number of UEs are affected by the change in slice to slice group mapping.

In principle, a third manner of informing the UE of updated slice group mapping is for the AMF to send the UE a configuration update by paging each UE individually, the configuration update containing the new slice to slice group mapping(s). The paged UEs will establish a connection to receive the slice group mapping(s). The third manner may be considered where the number of UEs to update is small.

The slice group mapping validity index, or the indication in the RRC short message that at least one slice group mapping has changed, act as a network slice group definition validity indication.

To address the problem of base stations not possessing the current information on the slice group mapping, a core network node, such as, for example, the AMF, may inform base stations impacted by a change in slice group mapping of this change, such that the base stations may update their slice frequency priorities and inform UEs using either the SIB-based method described above, or the RRC short message based method described above. UEs may use the slice frequency priorities to select a frequency to measure when searching for a cell to re-select to. The slice frequency priorities may be updated in order to thereby advise UEs to seek other frequencies if a slice is no longer deployed at a given frequency. The core network node, such as AMF, may learn of the updated slice group mapping by being informed of it by one of the base stations affected by the change, or the core network node may itself detect that a re-grouping of the slices into slice groups is needed and as such may update the slice group mapping.

As another alternative solution to the problem of the base stations not being current on the slice group mapping, base stations may inform each other of changes in the slice group mapping, for example in case a new slice addition, or existing slice removal, is configured locally affecting one, or a few, base stations and their cells. They may then inform the UEs, for example using either the SIB-based method described above, or the RRC short message based method described above. Yet further, an operation and maintenance system, OMS, may inform a base station of the changes in the slice group mapping.

In general, base stations may be configured to process an instruction defining a method the apparatus is to use in informing the at least one user equipment of the network slice group validity index. For example, the instruction may instruct the base station to use the SIB-based method, or the RRC short message based method. In case an instruction is not received, the base stations may be configured to employ a default method from among the herein disclosed methods to inform the UEs.

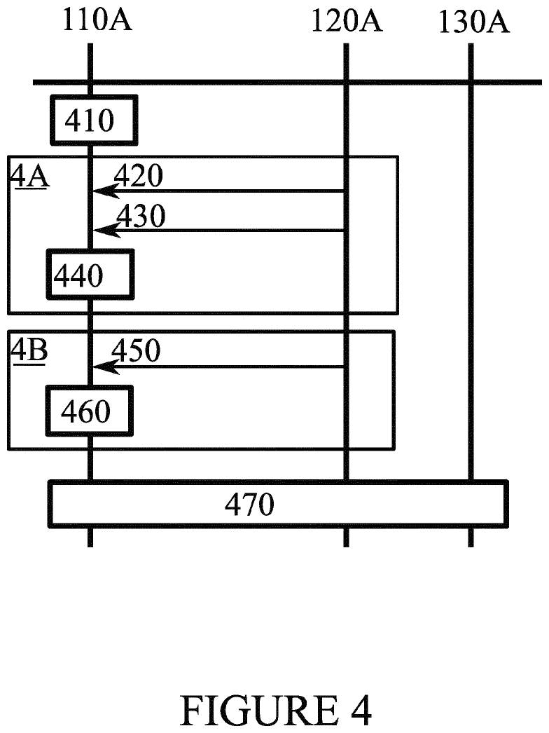

The embodiments described above may apply to slice group mappings that are valid per tracking area. One trigger for a slice group mapping change may be a change in tracking area scope. Another change to slice group mapping may be related to changes of security requirements on the UE side. At least some embodiments will be described below in more detail with reference to FIGS. 4A-4D.

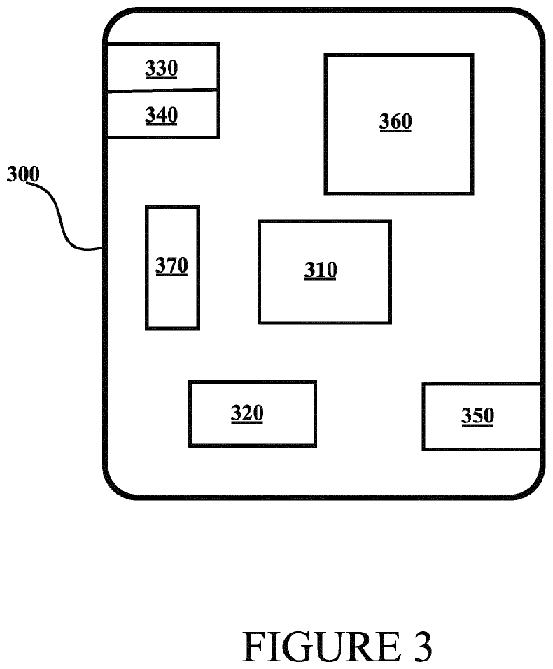

FIG. 3 illustrates an example apparatus capable of supporting at least some embodiments of the present invention. Illustrated is device 300, which may comprise, for example, a UE or, in applicable parts, a base station of FIG. 1. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Core processor. Processor 310 may comprise at least one application-specific integrated circuit, ASIC. Processor 310 may comprise at least one field-programmable gate array, FPGA. Processor 310 may be means for performing method steps in device 300, such as camping, processing, triggering, obtaining, performing, controlling, processing, providing, transmitting and receiving. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may be non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

FIG. 4 illustrates signalling in accordance with at least some embodiments of the present invention. On the vertical axes are disposed, from the left, of FIG. 1, UE 110A, base station 120A, and on the right, core network node 130A, for example an AMF. Time advances from the top toward the bottom.

In the initial phase 410, UE 110A is camped in idle state in a cell controlled by base station 120A. Then follows either process 4A or 4B, before phase 470.

In process 4A, in phase 420 base station 120A provides the RRC short message to UE 110A, informing the UE that SIB has changed. The UE reacts to this by receiving the changed SIB in phase 430, which carries the network slice group validity index which identifies which slice groups have changed mappings, that is, compositions of network slices. In phase 440 the UE determines, if the changes in mapping affect it. If not, the UE will ignore the changes and the process ends, however if the change(s) affect the UE, the UE may select a random or pseudorandom delay in phase 440 and after the delay has ended processing advances to phase 470. For example, the changes do not affect the UE in case slices and slice groups the UE uses are unaffected by the change(s).

In process 4B, base station 120A provides in phase 450 an RRC short message including an indication of changed slice group mapping. UE determines, if the changes in mapping affect it. If not, the UE will ignore the changes and the process ends, however if the change(s) affect the UE, and responsively, the UE selects a random or pseudorandom delay in phase 460, and after the delay has ended, processing advances to phase 470.

The UE may remain in idle state during process 4A, 4B. In phase 470, a NAS registration update is triggered from the UE to obtain the new mapping of networks slices to slice groups, to enable correct cell reselection decisions going forward.

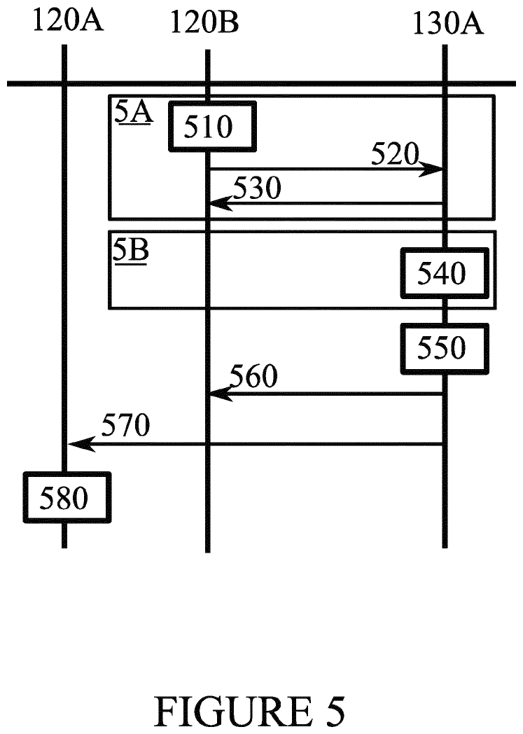

FIG. 5 illustrates signalling in accordance with at least some embodiments of the present invention. On the vertical axes are base stations 120A and 120B on the left, and core network node 130A, such as, for example, an AMF, on the right. Time advances from the top toward the bottom.

Trigger 5A or 5B may precede phase 550. In trigger 5A, slice group mapping is updated for base station 120B, which informs core network node 130A of this in phase 520. The message of phase 520 may be acknowledged in phase 530. Trigger 5B, on the other hand, comprises that the slice group mapping is updated directly in core network node 130A.

In phase 550, core network node 130A determines, that a slice group validity update needs to be sent, based on trigger 5A or trigger 5B. Further, core network node 130A may choose the manner of delivering this information to UEs, namely whether the SIB method or RRC short message method, described above, will be used. If a small number of UEs, below a threshold, are concerned, the core network node may use the third manner of informing UEs described above, based on UE configuration update. If the number of UEs is below the threshold, the core network node may inform the RAN nodes that they don't need to take steps to inform the UEs. This informing may be implicit, for example an absence of an indication that the SIB method or RRC short message should be used.

In phases 560 and 570, each base station affected by the change in slice group mapping is informed of the slice group validity index, which identifies which slice groups have had their composition changed. The messages of phases 560 and 570 may further comprise an indication as to whether the SIB method or RRC short message method should be used in informing UEs of the updated slice group mapping.

Finally in phase 580, the base station(s) informed in phases 560 and 570 take the new slice group mapping into use, and inform idle state UEs camping in their cells of the change, using either the SIB method or RRC short message method, as described herein above. The SIB method involves providing the slice group validity index to the UEs, while the RRC short message method only informs the UE that at least one change was made in slice group mapping(s). The same information is used to update frequency priorities by the base station(s) 120A and 120B.

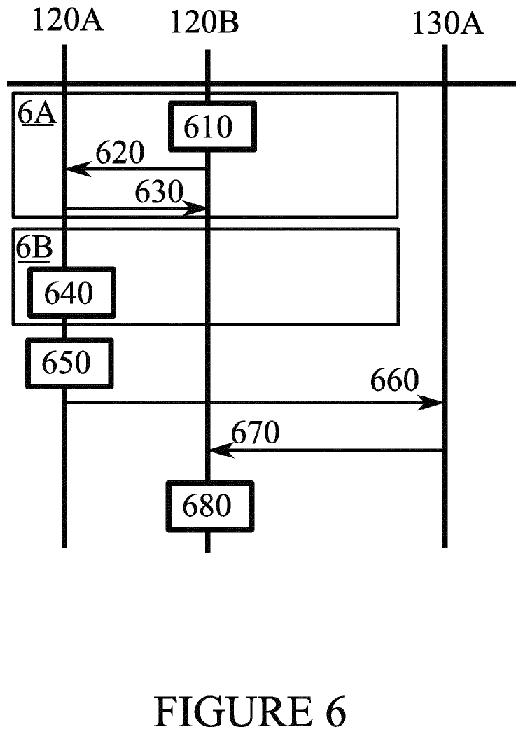

FIG. 6 illustrates signalling in accordance with at least some embodiments of the present invention. The vertical axes correspond to those of FIG. 5. Time advances from the top toward the bottom. In the process of FIG. 6, base stations are informed of changed slice group mappings by peer base stations. One of two alternative triggers 6A and 6B precedes phase 650.

In trigger option 6A, in phase 610 at least one slice group mapping is updated locally in base station 120B. Base station 120B informs base station 120A of the change, phase 620, for example in a RAN configuration update, which may proceed via an inter-base station interface, such as an Xn interface, or via the core network, such as via an NG-AP interface. The message of phase 620 may be acknowledged as phase 630.

Alternatively, in trigger option 6B, the at least one slice group mapping is locally updated in base station 120A, phase 640. In other words, in this trigger option base station 120A need not be informed of the update in slice group mapping by another base station.

In phase 650, base station 120A resolves to inform idle state UEs of the change in slice group mapping, based on either trigger 6A or 6B. In phase 660, base station 120A informs core network node 130A, such as the AMF, the slice group validity index and, optionally, an indication as to whether idle UEs should be informed of the change using the SIB method or the RRC short message method. If the number of UEs is below a threshold, the AMF may perform the updating using the UE configuration update process, as in the process of FIG. 5. Core network node 130A informs base station 120B of the contents of the message of phase 660 in phase 670. Alternatively, base station 120A may, instead of using core network node 130A, inform its peer base station node 120B directly of the slice group validity index and the optional indication as to whether idle UEs should be informed of the change using the SSB method or the RRC short message method. If the direct option is used, it may proceed via an inter-base station interface, for example.

Finally, in phase 680, base station 120B takes the new network slice group mapping into use, for example by updating frequency priorities, and informs idle state UEs camping on its cells, using the SIB method or the RRC short message method. In case the optional indication as to which of these methods is present in phase 670, then base station 120B may be configured to use the indicated method.

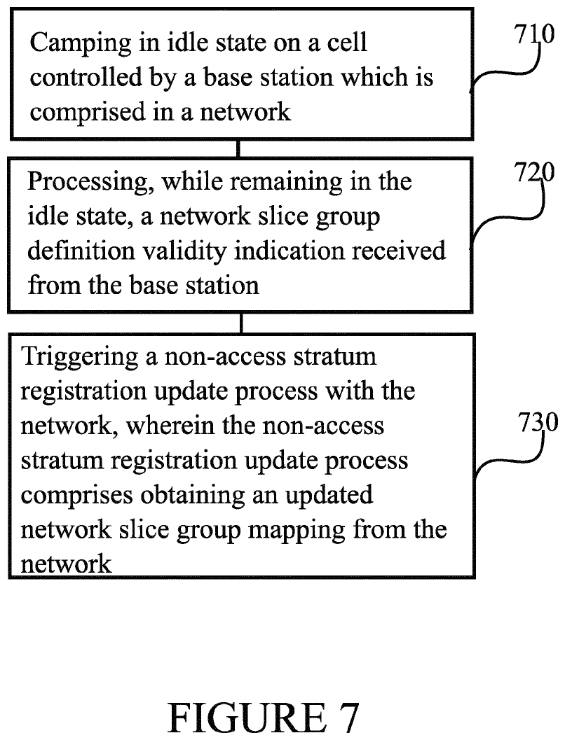

FIG. 7 is a flow graph of a method in accordance with at least some embodiments of the present invention. The phases of the illustrated method may be performed in a user equipment, for example, or in a control device configured to control the functioning thereof, when installed therein.

Phase 710 comprises camping in idle or inactive state on a cell controlled by a base station which is comprised in a network. Phase 720 comprises processing, while remaining in the idle or inactive state, a network slice group definition validity indication received from the base station. Finally, phase 730 comprises triggering a non-access stratum registration update process with the network, wherein the non-access stratum registration update process comprises obtaining an updated network slice group mapping from the network. Further, the method may comprise using the updated network slice group mapping in a subsequent cell re-selection.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in operating cellular communication networks.

### ACRONYMS LIST

3GPP 3^{rd} generation partnership project
NAS non-access stratum
NSSAI single-network slice selection assistance information
RRC radio resource control

### REFERENCE SIGNS LIST

| 110A, 110B, 110C, 110D | user equipment, UE |
|---|---|
| 120A, 120B | radio access node, e.g. base station |
| 130A | core network node |
| 130B | gateway |
| 300-370 | structure of the device of FIG. 3 |
| 410-470 | phases of the process of FIG. 4 |
| 510-580 | phases of the process of FIG. 5 |
| 610-680 | phases of the process of FIG. 6 |
| 710-730 | phases of the method of FIG. 5 |

### TECHNICAL CLAUSES

Clause 1. An apparatus comprising at least one processing core and at least one memory storing instructions that, when executed by the at least one processing core, cause the apparatus at least to:
   camp in idle or inactive state in a cell controlled by a base station which is comprised in a network;
   process, while remaining in the idle or inactive state, a network slice group definition validity indication received from the base station;
   trigger a non-access stratum registration update process with the network, wherein the non-access stratum registration update process comprises the apparatus obtaining an updated network slice group mapping from the network, and
   use the updated network slice group mapping in a subsequent cell re-selection.
Clause 2. The apparatus according to Clause 1, wherein the apparatus is configured to obtain, while in the idle or inactive state, the network slice group definition validity indication from a system information block, and to trigger the non-access stratum registration update process with the network, as a response to determining based on the network slice group definition validity indication that network slice to slice group mapping has changed in a way that affects the apparatus.
Clause 3. The apparatus according to Clause 2, wherein the network slice group definition validity indication comprises a network slice group validity index indicating which network slice group definitions have changed.
Clause 4. The apparatus according to Clause 2, wherein the network slice group definition validity indication comprises a network slice group validity index indicating a version of at least one slice group definition.
Clause 5. The apparatus according to Clause 1, wherein the apparatus is configured to obtain the network slice group definition validity indication from a radio resource control message conveyed over a downlink control channel and addressed to the apparatus using a radio network temporary identifier, the network slice group definition validity indication indicating that at least one network slice group definition has changed, wherein the apparatus is configured to perform the triggering of the non-access stratum registration update process as a response to processing the obtained network slice group definition validity indication.
Clause 6. The apparatus according to Clause 1, wherein the apparatus is configured to perform the triggering of the non-access stratum registration update process after a randomly or pseudo-randomly selected time delay after receiving the message.
Clause 7. An apparatus comprising at least one processing core and at least one memory storing instructions that, when executed by the at least one processing core, cause the apparatus at least to:
   control at least one cell of a cellular communication network;
   process a network slice group validity index indicating which network slice to slice group mappings have changed, and
   provide, by broadcasting in system information of the cell or by transmission via a physical downlink control channel of the cell, a network slice group definition validity indication to at least one user equipment camping in idle or inactive state in the cell.
Clause 8. The apparatus according to Clause 7, wherein the apparatus is configured to receive the network slice group validity index from a core network node of the cellular communication network, and/or to transmit the slice group validity index to the core network node of the cellular communication network.
Clause 9. The apparatus according to Clause 7, wherein the apparatus is configured to receive the network slice group validity index from at least one of a radio access network node of the cellular communication network and an operation and maintenance system, or to compile the network slice group validity index itself.
Clause 10. The apparatus according to any of Clauses 7-9, further configured to process an instruction defining a method the apparatus is to use in informing the at least one user equipment of the network slice group validity index.
Clause 11. The apparatus according to Clause 10, wherein the method comprises either transmitting the network slice group validity index as the network slice group definition validity indication by the broadcasting in the system information block, or transmitting the network slice group definition validity indication via a downlink message to prompt the at least one user equipment to trigger a non-access stratum registration update process to obtain the updated network slice group mapping and the related validity index.
Clause 12. A method comprising:
   camping in idle or inactive state on a cell controlled by a base station which is comprised in a network;
   processing, while remaining in an idle or inactive state, a network slice group definition validity indication received from the base station;
   triggering a non-access stratum registration update process with the network, wherein the non-access stratum registration update process comprises obtaining an updated network slice group mapping from the network, and
   using the updated network slice group mapping in a subsequent cell re-selection.
Clause 13. The method according to Clause 12, further comprising obtaining, while in the idle or inactive state, the network slice group definition validity indication from a changed system information block, and triggering the non-access stratum registration update process with the network, as a response to determining based on the network slice group definition validity indication that network slice to slice group mapping has changed in a way that affects an apparatus performing the method.
Clause 14. The method according to Clause 13, wherein the network slice group definition validity indication comprises a network slice group validity index indicating which network slice group definitions have changed.
Clause 15. The method according to Clause 13, wherein the network slice group definition validity indication comprises a network slice group validity index indicating a version of at least one slice group definition.
Clause 16. The method according to Clause 12, wherein the network slice group definition validity indication is comprised in a radio resource control message conveyed over a downlink control channel and addressed to the apparatus using a radio network temporary identifier, the network slice group definition validity indication indicating that at least one network slice group definition has changed, wherein the triggering of the non-access stratum registration update process takes place as a response to processing the obtained network slice group definition validity indication.
Clause 17. The method according to any of Clauses 12-16, wherein the triggering of the non-access stratum registration update process takes place after a randomly or pseudo-randomly selected time delay after receiving the message.
Clause 18. A method comprising:
   controlling at least one cell of a cellular communication network;
   processing a network slice group validity index indicating which network slice to slice group mappings have changed, and
   providing, by broadcasting in system information of the cell or by transmission via a physical downlink control channel of the cell, a network slice group definition validity indication to at least one user equipment camping in idle state on the cell.
Clause 19. The method according to Clause 18, further comprising receiving the network slice group validity index from a core network node of the cellular communication network and/or to transmitting the slice group validity index to the core network node of the cellular communication network.
Clause 20. The method according to Clause 18, further comprising receiving the network slice group validity index from at least one of a radio access network node of the cellular communication network and an operation and maintenance system, or compiling the network slice group validity index.
Clause 21. The method according to any of Clauses 19-20, further comprising processing an instruction defining a method to be used in informing the at least one user equipment of the network slice group validity index.
Clause 22. The method according to Clause 21, wherein the method comprises either transmitting the network slice group validity index as the network slice group definition validity indication by the broadcasting in the system information block, or the transmitting the network slice group definition validity indication via a downlink message to prompt the at least one user equipment to trigger a non-access stratum registration update process to obtain the updated network slice group mapping.
Clause 23. An apparatus comprising:
   means for camping in idle or inactive state on a cell controlled by a base station which is comprised in a network;
   means for processing, while remaining in the idle or inactive state, a network slice group definition validity indication received from the base station, and
   means for triggering a non-access stratum registration update process with the network, wherein the non-access stratum registration update process comprises the apparatus obtaining an updated network slice group mapping from the network, and
   means for using the updated network slice group mapping in a subsequent cell re-selection.
Clause 24. An apparatus comprising:
   means for controlling at least one cell of a cellular communication network;
   means for processing a network slice group validity index indicating which network slice to slice group mappings have changed, and
   means for providing, by broadcasting in system information of the cell or by transmission via a physical downlink control channel of the cell, a network slice group definition validity indication to at least one user equipment camping in idle state on the cell.
Clause 25. A non-transitory computer readable medium having stored thereon a set of computer readable instructions that, when executed by at least one processor, cause an apparatus to at least:
   camp in idle or inactive state on a cell controlled by a base station which is comprised in a network;
   process, while remaining in the idle or inactive state, a network slice group definition validity indication received from the base station;
   trigger a non-access stratum registration update process with the network, wherein the non-access stratum registration update process comprises the apparatus obtaining an updated network slice group mapping from the network, and
   use the updated network slice group mapping in a subsequent cell re-selection.
Clause 26. A non-transitory computer readable medium having stored thereon a set of computer readable instructions that, when executed by at least one processor, cause an apparatus to at least:
   control at least one cell of a cellular communication network;
   process a network slice group validity index indicating which network slice to slice group mappings have changed, and
   provide, by broadcasting in system information of the cell or by transmission via a physical downlink control channel of the cell, a network slice group definition validity indication to at least one user equipment camping in idle state on the cell.

1.-15. (canceled)

16. An apparatus comprising at least one processing core and at least one memory storing instructions that, when executed by the at least one processing core, cause the apparatus at least to:
camp in idle or inactive state in a cell controlled by a base station which is comprised in a network;
process, while remaining in the idle or inactive state, a network slice group definition validity indication received from the base station;
trigger a non-access stratum registration update process with the network, wherein the non-access stratum registration update process comprises the apparatus obtaining an updated network slice group mapping from the network, and
use the updated network slice group mapping in a subsequent cell re-selection.

17. The apparatus according to claim 16, wherein the apparatus is configured to obtain, while in the idle or inactive state, the network slice group definition validity indication from a system information block, and to trigger the non-access stratum registration update process with the network, as a response to determining based on the network slice group definition validity indication that network slice to slice group mapping has changed in a way that affects the apparatus.

18. The apparatus according to claim 17, wherein the network slice group definition validity indication comprises a network slice group validity index indicating which network slice group definitions have changed.

19. The apparatus according to claim 17, wherein the network slice group definition validity indication comprises a network slice group validity index indicating a version of at least one slice group definition.

20. The apparatus according to claim 16, wherein the apparatus is configured to obtain the network slice group definition validity indication from a radio resource control message conveyed over a downlink control channel and addressed to the apparatus using a radio network temporary identifier, the network slice group definition validity indication indicating that at least one network slice group definition has changed, wherein the apparatus is configured to perform the triggering of the non-access stratum registration update process as a response to processing the obtained network slice group definition validity indication.

21. The apparatus according to claim 16, wherein the apparatus is configured to perform the triggering of the non-access stratum registration update process after a randomly or pseudo-randomly selected time delay after receiving the message.

22. An apparatus comprising at least one processing core and at least one memory storing instructions that, when executed by the at least one processing core, cause the apparatus at least to:
control at least one cell of a cellular communication network;
process a network slice group validity index indicating which network slice to slice group mappings have changed, and
provide, by broadcasting in system information of the cell or by transmission via a physical downlink control channel of the cell, a network slice group definition validity indication to at least one user equipment camping in idle or inactive state in the cell.

23. The apparatus according to claim 22, wherein the apparatus is configured to receive the network slice group validity index from a core network node of the cellular communication network, and/or to transmit the slice group validity index to the core network node of the cellular communication network.

24. The apparatus according to claim 22, wherein the apparatus is configured to receive the network slice group validity index from at least one of a radio access network node of the cellular communication network and an operation and maintenance system, or to compile the network slice group validity index itself.

25. The apparatus according to claim 22, further configured to process an instruction defining a method the apparatus is to use in informing the at least one user equipment of the network slice group validity index.

26. The apparatus according to claim 25, wherein the method comprises either transmitting the network slice group validity index as the network slice group definition validity indication by the broadcasting in the system information block, or transmitting the network slice group definition validity indication via a downlink message to prompt the at least one user equipment to trigger a non-access stratum registration update process to obtain the updated network slice group mapping and the related validity index.

27. A non-transitory computer readable medium having stored thereon a set of computer readable instructions that, when executed by at least one processor, cause an apparatus to at least:
camp in idle or inactive state on a cell controlled by a base station which is comprised in a network;
process, while remaining in the idle or inactive state, a network slice group definition validity indication received from the base station;
trigger a non-access stratum registration update process with the network, wherein the non-access stratum registration update process comprises the apparatus obtaining an updated network slice group mapping from the network, and
use the updated network slice group mapping in a subsequent cell re-selection.
